(19) United States
(12) Patent Application Publication
(10) Pub. No.: US 2012/0267349 A1
(43) Pub. Date: Oct. 25, 2012

(54) JOINING DEVICE FOR NON-POSITIVE JOINING BY MEANS OF A FILLER MATERIAL USING SENSORS

(75) Inventors: Jurgen Berndl, Nandlstadt (DE); Steffen Walter, Berlin (DE); Thomas Kischke, Glienicke (DE); Igor Haschke, Berlin (DE)

(73) Assignees: BAYERISCHE MOTOREN WERKE AG, Munchen (DE); SCANSONIC MI GMBH, Berlin (DE)

(21) Appl. No.: 13/499,955

(22) PCT Filed: Sep. 29, 2010
(86) PCT No.: PCT/EP2010/063779

§ 371 Date: Jun. 25, 2012

(30) Foreign Application Priority Data
Oct. 6, 2009 (DE) 10 2009 045 400.4

(51) Int. Cl. B23K 26/06; B23K 26/20

(52) U.S. Cl. 219/121.65

(57) ABSTRACT

A joining device for a bonded connection by means of a filler material has a feeding device for a wire as the filler material, which is configured to feed the wire during operation of the joining device at a predetermined speed of advance, and a guiding device for an energy beam with at least two partial beams for the melting of the wire. The joining device has a first measuring sensor for detecting a lateral deflection of the wire and a second measuring sensor for detecting a quantity related to the advancement of the wire, wherein the guiding device for the energy beam is connected to the first and the second measuring sensor and configured such that the energy beam is deflected and/or focused in dependence on the output signals of the first and second measuring sensor.

The invention concerns a joining device for a bonded connection by means of a filler material with a feeding device for a wire as the filler material, which is configured to feed the wire during operation of the joining device at a predetermined speed of advance, and a guiding device for an energy beam with at least two partial beams for the melting of the wire.

From DE 10 2006 056 252 A1, a device is known for guiding an energy beam along a joint of two materials to be joined by an energy beam. Moreover, a guide finder is provided, which is pretensioned with a pressing force against the joint.

From EP 1 568 435 A1, a laser processing machine is known with a focusing device. The machining zone of a work piece is monitored here by means of a sensor.

DE 10 2006 060 116 A1 shows a laser machining head. A sensor is provided, which is coordinated with a wire, and by means of which a force acting on the wire is measured.

A device of the kind mentioned above is known, for example, from DE 10 2004 025 873 A1. In the device specified there, a laser beam is split into a plurality of partial beams, which are focused by a focusing lens in the work zone. The focusing lens has a central opening through which the filler material is led. Thus, there is a coaxial wire feeding.

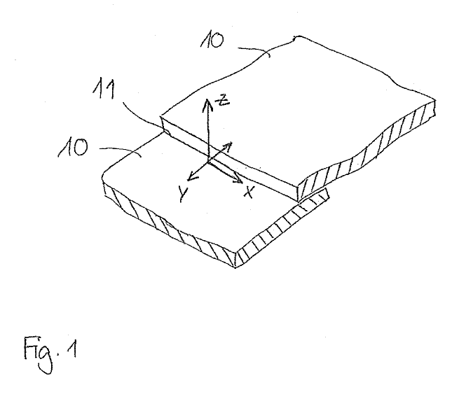

With such a configuration, a seam produced by a melting wire cannot be produced with uniform seam quality along a joint of two structural parts when the position of the joint changes, e.g., due to tolerances of the structural parts. The joining device cannot be positioned in ongoing operation with sufficient accuracy to an even minimally changing joint, i.e., the partial beams and the wire cannot move, or can do so only slightly, in and transversely to the direction of advancement of the joining device, as well as vertically (i.e., in the x, y and z direction of FIG. 1). This can lead to non-optimal depth and bonding cross section of the resulting joint seam.

The problem of the invention is to provide a joining device which can be used to make an optimal joint seam.

For this purpose, the invention provides a joining device of the aforementioned kind, wherein the joining device has a first measuring sensor for detecting a lateral deflection of the wire and a second measuring sensor for detecting a quantity related to the advancement of the wire, wherein the guiding device for the energy beam is connected to the first and the second measuring sensor and configured such that the energy beam is deflected and/or focused in dependence on the output signals of the first and second measuring sensor.

According to the invention, upon a change in the position of the wire in a joint, it is not the position of the overall joining device relative to the parts being joined and the joint seam that is changed, but rather only the position of the energy beam relative to the wire that is corrected. The energy beam is deflected in dependence on the position of the wire (i.e., in the x and/or y direction of FIG. 1) and/or focused in the z-direction. In particular, the energy beam is deflected and/or focused so that the wire lies between the at least two partial beams. In this position of the wire, an optimal joint seam is achieved. According to the invention, tolerances of the parts being joined are equalized by the subsequent deflection and/or focusing of the energy beam that is possible during the operation. This achieves a high, reproducible seam quality and improves the process safety.

Preferably, the first measuring sensor comprises a sensor that is connected to the feeding device or the wire and configured to detect the force resulting from a lateral deflection of the wire, thereby detecting the lateral position of the wire relative to the joint. In the application as a whole, the term “lateral” deflection is to be understood as meaning a deflection in the x or y direction. The force is detected in the x and y direction for an orientation-independent design.

It is possible to provide an optical sensor arranged on the joining device, such as a camera. The camera is then arranged on the joining device such that it back-lights the wire and the wire is imaged on an optical element to determine its optical center of gravity. As the optical element on which the wire is imaged one can use, for example, a quadrant photodiode (QPD for short), a position sensitive device (PSD for short) or a photodiode array (PDA for short). In this way, one detects the lateral position (i.e., the position of the wire in the x and/or y direction) of the wire relative to the joint and especially the deformation which the wire experiences from the pressing force against the joint. The lateral position of the joint could also be detected by observing the relative position of the joint to the beam spots formed by the partial beams of the energy beam.

Alternatively, the sensor is an inductive sensor that emits an electromagnetic field that produces eddy currents in an electrically conducting material moving past it, in this case the wire. An oscillator recognizes the change in the eddy currents. The deformation which the wire experiences by the pressing force against the joint and, along with it, the lateral position of the wire can thus be detected. The sensor can also be a force sensor.

The first measuring sensor preferably has a camera and an evaluation device, wherein the evaluation device evaluates an image produced by the camera in order to detect the position of the wire relative to the joint. In particular, the position of the joint is detected by means of gray value features, i.e., brightness or intensity values of a pixel, and/or color features.

Preferably, the second measuring sensor contains a sensor that is connected to the feeding device or the wire and configured to detect the quantity related to the advancement of the wire.

For example, the wire is led in a Bowden cable, wherein the Bowden cable is deflected by 90°, for example, in order to accomplish a decoupling of the forces by which the wire is pushed in. The Bowden cable is fastened to a support in the area of the feeding device, so that this will be pushed away from the joint by virtue of the feeding force of the wire. This force can be detected, e.g., by means of a distance sensor, which is arranged in the area of the support. Such a distance sensor can be an elastic spring element whose degree of compression indicates the feeding force acting on the wire. Instead of a Bowden cable, the wire could be received in a tube. Alternatively, rollers can be provided in the area of the support that detect a force acting on the wire. Quite generally, a strain gage strip, a force sensor, [or] a distance sensor can be provided to detect the quantity associated with the feed of the wire.

Preferably, a sensor is provided for detecting the vertical deflection (i.e., in the z direction) of the wire or the feeding device.

It is possible to use a capacitive sensor, which is preferably located in the wire nozzle. A capacitive sensor works quite generally with a high-frequency oscillatory circuit, which generates an electric field by means of a capacitor. If a solid substance approaches this field, there is a change in the capacitance and, thus, a change in the gain in the oscillatory circuit. Once this gain exceeds a threshold value, a switching signal is generated.

The sensor for detecting the vertical deflection can just as well be an autocorrelation sensor, which is installed in a camera. The correlation sensor is placed in the coaxial beam path and regulates the optical elements so that they are always in focus. Thus, the device can be regulated optically in the z direction.

According to the preferred embodiment, the at least two partial beams of the energy beam are led essentially symmetrically to the wire, and between one partial beam of the energy beam and the wire there is an angle of at least 5°. The result is an effective feeding of the wire and thus a high joint quality with a sufficient seam depth, since the wire is fed centrally to the partial beams. The vertical active direction for the movement of the wire or the feeding device runs along the z axis of the joining device. This direction of application can also be inclined by an angle, so that a movement of the wire along the inclined energy beam occurs.

Preferably, at least one autofocus module is provided, which focuses the energy beam in dependence on output signals of the first and the second measuring sensor. Thanks to the autofocus module, the energy beam, i.e., the partial beams of the energy beam, is changed specifically. It can also be provided that the individual partial beams are influenced independently of each other. The autofocus module can be configured, e.g., as a collecting lens, a spherical lens, or intersecting cylindrical lenses. The focus position, or focal spot of a lens system, can be changed so that the focus lies either above the surface of the parts being joined or below it. In particular, the distance of the respective focus of the at least two partial beams from the wire should be held constant.

One can provide one or more means of influence in the form of a mirror or a plane-parallel plate, which deflect and/or split the energy beam. The mirror and/or the plane-parallel plate are arranged at an angle to the energy beam, so that the path of the energy beam is changed. One can equally conceive of swiveling the mirror and/or the plane-parallel plate into various positions, before or during the soldering or welding process. In this case, the partial beams are oriented relative to the wire end.

According to one embodiment, an actuator is provided on the joining device, which can move a part of the joining device in the vertical direction (i.e., the z direction). This changes the distance of the joining device from the parts being joined.

One part of the joining device can preferably swivel along a swivel axis. For this, a swivel drive is provided, which is arranged between a laser collimation and a laser focus. The swivel drive serves to correct the lateral position.

In particular, a sensing element is provided, wherein the vertical and/or lateral force acting on the sensing element can be detected.

Preferably, the wire is acted upon by an actuator or by an elastic spring element in the direction of a joint seam being produced. In this way, a practically constant force acts on the distal end of the wire in the direction of a joint seam being produced, which makes it possible to produce a uniform joint seam.

According to one embodiment, a nozzle is provided with a slot, by means of which the wire is fed. The slot is made in the nozzle in the feed direction (x direction). This enables a movement of the wire in the x direction when the wire has a large free length.

The guiding device for the energy beam is preferably configured such that the energy beam is deflected transversely and in the feeding direction, i.e., in the y and x direction. Thus, measurement and deflection are in principle possible in two directions.

In addition, according to the invention the energy beam can be held constant in the machining plane at a distance from the wire impact point, in dependence on output signals of the first and second measuring sensor.

Protective gas or air can be supplied to the process, coaxially to the wire and/or the energy beam. The gas supplied serves as process gas and/or to cool down the heat-stressed parts in the process seam.

Other features and advantages will emerge from the subclaims.

The invention will be described hereafter by means of an embodiment, which is shown in the drawings. The drawings show:

FIG. 1 a schematic view of two parts being joined with a system of coordinates,

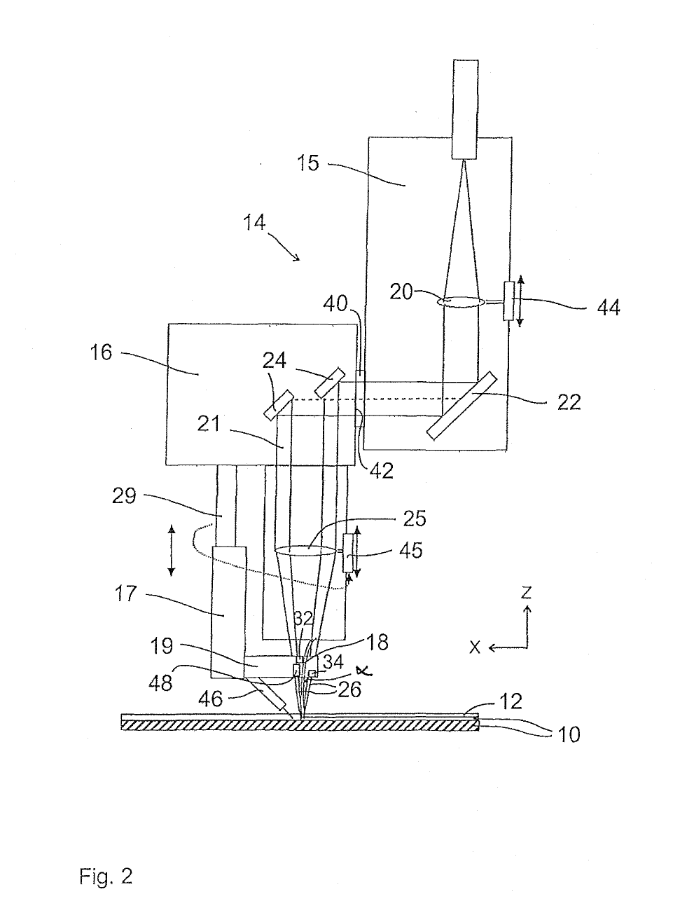

FIG. 2 a side view of a joining device according to the invention,

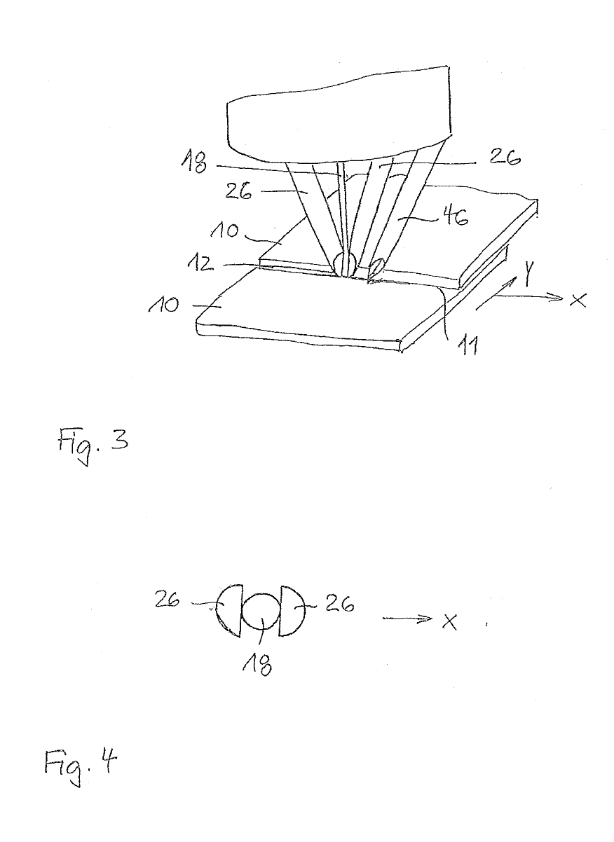

FIG. 3 a partial perspective view of the joining device of the invention with a sensing element,

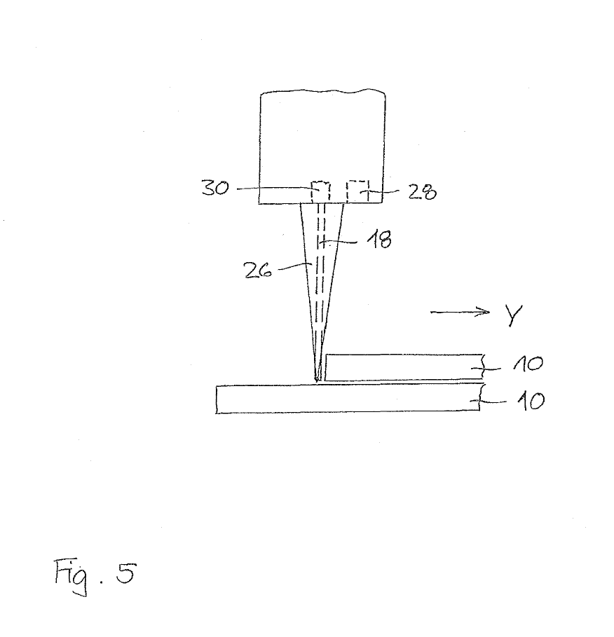

FIG. 4 a top view of an energy beam and a wire,

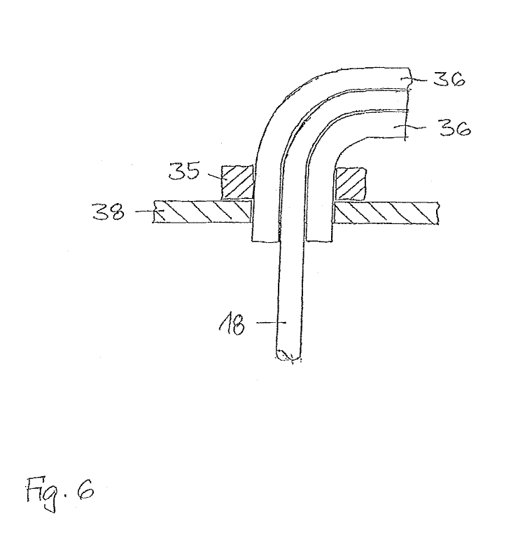

FIG. 5 a schematic side view of the joining device,

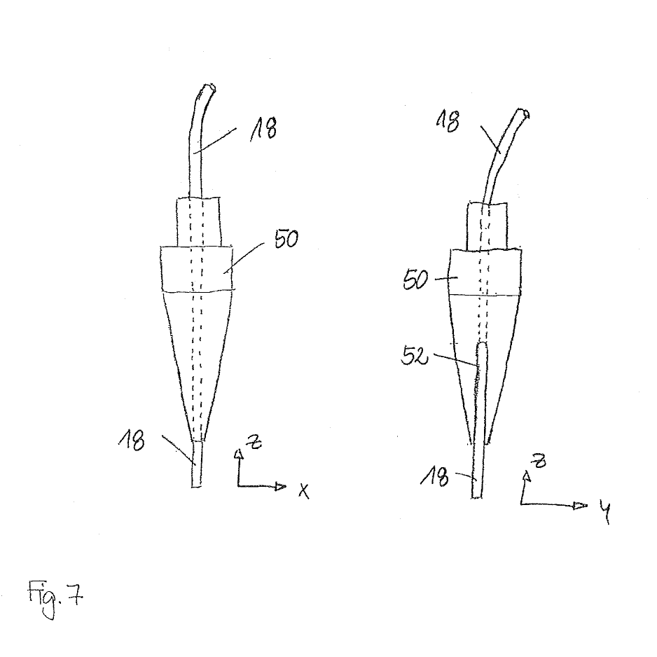

FIG. 6 in an enlarged scale, the region designated X in FIG. 1, and

FIG. 7 in an enlarged scale, a nozzle serving for the wire feed.

In FIG. 1 are shown two partially overlapping parts 10, which are to be joined together in the region of a joint 11. A system of coordinates explains the directions, wherein a joint seam 12 being produced runs in the x direction, the vertical direction is designated z and the direction perpendicular to the joint seam being produced, i.e., to the x direction, is designated y.

FIG. 2 shows the two partially overlapping structural parts 10, which are already joined together by means of the seam 12 in the right side of FIG. 2. A joining device 14 is provided for the connection of the two parts, which moves along the joint 11 in the x direction (see FIG. 1).

The joining device 14 has a fastening element 15, a structural part 16 and an element 17 with a sensing element 46 and a feeding device 19, while a swivel axis 42 with a swivel drive 40 is provided between the fastening element 15 and the structural part 16. The structural part 16 and the element 17 can swivel about the swivel axis 42.

Between the element 16 and the element 17 there is provided a telescopic arm 29, enabling a movement in the z direction. The feeding device 19 is arranged on the element 17, by which a filler material, especially a wire 18, is fed with a predetermined speed of advancement. The sensing element 46 is firmly joined to the feeding device 19.

Moreover, the joining device 14 has a guiding device 21 for at least one energy beam for the melting of the filler material. The filler material is melted during the joining of the structural parts 10.

The guiding device 21 is coupled to the movement of the feeding device 19, as suggested by the dotted arrow in FIG. 2 and explained more closely below.

The energy beam is preferably a laser beam focused and/or deflected by a first autofocus module 20 in the form of a collimator lens, several mirrors 22, 24 (three are shown in FIG. 2), and a second autofocus module 25 in the form of a lens, so that two partial beams 26 are formed, which after emerging from the joining device 14 run essentially symmetrically to the wire 18, while between one partial beam 26 of the energy beam and the wire 18 there is an angle α of at least 5°. In particular, the first autofocus module 20 (shown schematically in FIG. 2) forms a parallel-oriented laser beam of adjustable diameter. The diameter of the laser beam can be adjusted by moving the first autofocus module 20 along the direction indicated by the arrow in parallel with the optical axis. After the laser beam has been deflected by means of a first mirror 22, the beam is split via two mirrors 24 set off from each other. For this purpose, one of the two staggered mirrors projects only halfway into the laser beam and thus deflects only a partial beam 26, namely, half of the laser beam, in a defined position onto the second autofocus module 25. The second half of the laser beam, i.e., the second partial beam 26, is reflected by a second, staggered mirror 24, again onto the second autofocus module 25, and thus impinges at a different spot on the second autofocus module 25. Thanks to this offset, two separate partial beams 26 are formed at the processing point. The inclusion of the mirror 24 in the beam-splitting deflection unit enables an adjustment of the mirror 24 in all directions during the assembly process. Furthermore, this adjustment mechanism enables an adjustment of the intensity distribution in the two partial beams. The system can be adjusted symmetrically, i.e., with identical intensities in both partial beams, or with different intensities for each partial beam.

The optics thus has two autofocus modules. The first autofocus module 20 serves for collimation of the divergent laser beam, i.e., the parallel direction of the beam, and for adjustment of the size of the beam spot. The second autofocus module 25 is a collecting lens, by means of which the two partial beams 26 are focused and deflected so that they run toward each other. Moreover, the second autofocus module 25 serves for the focusing.

The second autofocus module 25 is coupled to the movement of the feeding device 19 in z-direction. In particular, the feeding device 19 is connected via the telescopic arm 29 to the guiding device 21, as indicated by the broken arrow in FIG. 2. The telescopic arm 29, on which the sensing element 46 is secured, can be moved in the z-direction (see arrows in FIG. 2). The second autofocus module 25 can also be moved in the z-direction (see arrows in FIG. 2). The second autofocus module 25 is displaced in dependence on the deflection of the telescopic arm 29. This ensures that the partial beams 26 impinging at an angle always have the same position in the x and y direction relative to each other and to the wire 18. An electrically driven actuator 45 is used in particular for the movement.

FIG. 3 shows the two partial beams 26 of the energy beam in a perspective side view, where it can be seen that each partial beam 26 seen in top view (cf. FIG. 4) has the shape of a semicircle or bowl, while the wire 18 in the feed direction x lies between the two semicircular or bowl-shaped partial beams 26. In this position, a desired depth of the joint seam 12 is achieved during the operation of the joining device 14. It is possible for the operator to adjust the positions of the semicircles or half-shells relative to the wire in the x direction and likewise the distance of the two half-moons relative to each other in the x direction in the installed state of the machining optics.

The guiding device 21 for the energy beam is connected to a first measuring sensor 28 and a second measuring sensor 30, which are shown schematically in FIG. 5 and shall be discussed hereafter. The guiding device 21 is configured such that the partial beams 26 of the energy beam are deflected and/or focused in dependence on signals from the two measuring sensors 28, 30. In particular, the partial beams 26 are deflected to the side by changing the position of the autofocus module or modules and/or one or more mirrors 22. By adjusting the autofocus modules, for example, the focus of the partial beams 26 is changed. By a sideways deflection of the partial beam or beams 26, the position of the energy beam is corrected. Thus, the partial beams 26 can be positioned relative to the end of the wire 18 so that this lies exactly between the two partial beams 26, as shown in FIG. 4.

The guiding device 21, as already mentioned, receives signals from the first measuring sensor 28. The first measuring sensor 28 detects a lateral deflection of the wire 18, i.e., a deflection of the wire 18 in the y direction. The first measuring sensor 28 has a camera 32, shown schematically in FIG. 2. The camera 32 is arranged on the joining device 14 and creates an image of the wire 18. This generated image can be evaluated by an evaluation device 34 in terms of gray-level features in order to detect the position of the wire 18 relative to the joint 11 and thus the lateral deflection of the wire 18. Depending on the detected lateral deflection of the wire 18, the energy beam is then deflected (in the x and/or y direction) and/or focused (in the y direction). Thus, upon change in the distance of the wire 18 relative to the edge of the joint, one does not need to change the distance of the entire joining device 14 relative to the joint, but only the position of the energy beam relative to the end of the wire.

Alternatively, the camera 32 arranged on the joining device 14 could back-light the wire 18. The image of the wire 18 is then produced on an optical element (not shown), and an evaluation device 34 can detect the lateral deflection of the wire 18. As the optical element on which the wire 18 is imaged one can use, for example, a quadrant photodiode (QPD for short) or a photodiode array (PDA for short).

The lateral deflection of the wire 18 can also be detected by an inductive sensor. Such an inductive sensor emits an electromagnetic field that produces eddy currents in the wire 18. An oscillator can detect a change in the eddy currents. Thus, the lateral deflection of the wire 18 can be detected and a corresponding signal be sent out to the guiding device 21.

The position of the wire 18 could be detected just as well by laser triangulation. In laser triangulation, a beam from a light source is emitted onto the wire and then the reflected beam is received by a receiver. Since the distance between the light source and the receiver remains constant and known, the position of the wire can be detected and a corresponding signal be sent to the guiding device 21.

Moreover, the guiding device 21, as already mentioned, contains signals of the second measuring sensor 30. The second measuring sensor 30 detects a quantity related to the feed of the wire 18 and has a sensor 35, shown in FIG. 6 in magnified view. The sensor 35 is arranged so that it detects a force acting on an end of the wire 18. The wire 18 is led in a Bowden cable 36, while the Bowden cable 36 is deflected by 90° to accomplish a decoupling of the forces by which the wire 18 is being advanced. One end of the Bowden cable 36 is fastened to a support 38, so that it will be pushed away from the seam 12 being produced on account of the feeding force of the wire 18. This force can be detected, e.g., by means of the sensor 35. The sensor 35 is an elastic spring element, for example, whose degree of compression indicates the feeding force acting on the wire 18 in the area of the joint. Instead of an elastic spring element, a strain gage strip can also be provided, which detects the quantity related to the feed of the wire.

The wire 18 could also be taken up in a specially shaped tube and impinge axially to the z axis on the process plane. The specially shaped tube enables a low-friction feeding of the wire, but at the same time it makes it possible to transmit the forces occurring due to distance changes in the z direction. The wire guidance module is designed to be adjustable in all directions (x, y and z direction). The wire guidance module can be fastened to a telescopic arm and has a sensor that detects the movement or the position in the z direction. The movement is transmitted by the wire 18 impinging on the machining surface. The signal is used to specify the movement for the lens system 20, 24.

Alternatively, rollers could also be provided to detect a force acting on the wire 18.

The partial beams 26 of the energy beam, as already mentioned, are deflected and/or focused in dependence on signals of the two measuring sensors 28, 30 to precisely position the end of the wire 18 between the partial beams 26, as shown in FIG. 4

A longer free wire length means that the wire 18 will bend. Therefore, the wire 18 wanders into the space formed by the partial beams 26, which in turn leads to an optimal melting. Thus, thanks to its longer free length, the wire 18 can swing back and forth to some degree, viewed in the x direction.

FIG. 2 shows a swivel drive 40, by means of which a portion of the joining device 14 can pivot along a swivel axis 42 in order to change the lateral position of the wire 18 and the partial beams 26. The lateral process control (y direction) occurs via the swivel drive 40. The guidance is force-regulated. The wire 18 is braced against the joint to the side. The resulting forces are measured by a force sensor and relayed by a corresponding regulating system to the swivel drive 40 for control of the movement. An actuator 44 is also provided on the joining device 14, which can move a portion of the joining device 14 in the vertical direction (i.e., the z direction). Moreover, by means of another actuator 45, the second autofocus module 25 can be adjusted in the vertical direction, as already mentioned. In this process, the vertical and/or lateral force (i.e., in the z direction and the y direction) acting on the sensing element 46 arranged in advance of the wire 18 (see FIGS. 2 and 3) is detected, along with the position of the joining device 14 relative to the parts 10 being joined.

The sensing element is adjustable in all directions and can have a channel (not shown) by which a flux agent and/or an added gas can be supplied during the making of the connection.

The feeding device 19 is acted upon by means of an actuator 48 (shown schematically in FIG. 2) in the direction of the seam 12 being produced, so that the wire 18 lies against the parts 10 being joined.

FIG. 7 shows a nozzle 50 by means of which the wire 18 is fed. A slot 52 is made in the nozzle 50—looking in the feed direction (x direction). This slot 52 enables a large free wire length in the x direction and thus a movement of the wire 18 in the feeding direction, while at the same time an exact positioning of the wire 18 in the y direction thanks to the small free wire length in this direction.

Protective gas or air (not shown) can be supplied to the process, coaxially to the wire and/or the energy beams. The supplied gas serves as process gas and/or to cool the heat-stressed parts in proximity to the process.

In addition to the autofocus modules and the mirrors, two plane-parallel plates can also be provided (not shown). The energy beam can be deflected by means of these plane-parallel plates.

1. A Joining device for a bonded connection by means of a filler material, with a feeding device for a wire as the filler material, which is configured to feed the wire during operation of the joining device at a predetermined speed of advance, and
a guiding device for an energy beam with at least two partial beams for the melting of the wire,
characterized in that
the joining device has a first measuring sensor for detecting a lateral deflection of the wire and
a second measuring sensor for detecting a quantity related to the advancement of the wire,
wherein the guiding device for the energy beam is connected to the first and the second measuring sensor and configured such that the energy beam is deflected and/or focused in dependence on the output signals of the first and second measuring sensor.

2. The joining device according to claim 1, characterized in that the first measuring sensor contains a sensor, which is connected to the feeding device or the wire and configured to detect the force resulting from a lateral deflection of the wire.

3. The joining device according to claim 1, characterized in that the first measuring sensor has a camera and an evaluation device, wherein the evaluation device evaluates an image produced by the camera in order to detect the lateral deflection of the wire.

4. The joining device according to claim 1, wherein the second measuring sensor contains a sensor that is connected to the feeding device or the wire and configured to detect the quantity related to the advancement of the wire.

5. The joining device according to claim 4, wherein the wire is led in a Bowden cable, wherein the end of the Bowden cable toward the end of the wire is fastened to a support and the sensor is arranged and configured so that the force acting on the Bowden cable can be detected.

6. The joining device according to claim 1, wherein a sensor is provided for detecting the vertical deflection of the wire or the feeding device.

7. The joining device according to claim 6, wherein the sensor for detecting the vertical deflection is a capacitive sensor.

8. The joining device according to claim 6, wherein the sensor for detecting the vertical deflection is an autocorrelation sensor that is installed in a camera.

9. The joining device according to claim 1, wherein the at least two partial beams of the energy beam are led essentially symmetrically to the wire, and between one partial beam of the energy beam and the wire there is an angle (α) of at least 5°.

10. The joining device according to claim 1, wherein at least one autofocus module is provided that focuses the energy beam in dependence on output signals of the first and the second measuring sensor.

11. The joining device according to claim 1, wherein one or more means of influencing in the form of a mirror or a plane-parallel plate are provided, which deflect and/or split the energy beam.

12. The joining device according to claim 10, wherein an actuator is provided on the joining device, which can move a part of the joining device in the vertical direction.

13. The joining device according to claim 1, wherein one part of the joining device can swivel along a swivel axis by means of a swivel drive.

14. The joining device according to claim 1, wherein a sensing element is provided, wherein the vertical and/or lateral force acting on the sensing element can be detected.

15. The joining device according to claim 1, wherein the feeding device is acted upon by an actuator in the direction of a joint seam being produced.

16. The joining device according to claim 1, wherein the guiding device for the energy beam is configured such that the energy beam is deflected transversely and in the feeding direction.

17. The joining device according to claim 1, wherein a nozzle is provided with a slot, by means of which the wire is fed.
